(19) United States
(12) Patent Application Publication
(10) Pub. No.: US 2025/0068933 A1
(43) Pub. Date: Feb. 27, 2025

(54) METHOD AND DEVICE FOR OPTIMIZING PARAMETERS OF BIOMETRIC RECOGNITION MODEL

(71) Applicant: Samsung Electronics Co., Ltd., Suwon-si (KR)

(72) Inventors: Pengtao ZHANG, Xi'an (CN); Chao MA, Xi'an (CN); Chao WEI, Xi'an (CN); Hao YANG, Xi'an (CN)

(73) Assignee: Samsung Electronics Co., Ltd., Suwon-si (KR)

(21) Appl. No.: 18/798,385

(22) Filed: Aug. 8, 2024

(30) Foreign Application Priority Data
Aug. 22, 2023 (CN) 202311062137.5

(51) Int. Cl. G06N 3/126

(52) U.S. Cl. CPC G06N 3/126

(57) ABSTRACT

A method and device for optimizing parameters of a biometric recognition mode are provided, the method includes: repeating steps of selecting a first test data set SI from current decision space based on Latin Hypercube Sampling (LHS), obtaining a first set O1 of multi-objective values corresponding to the set S1 determined based on original evaluation and determining a first Pareto solution set of the set SI based on the set O1, wherein the decision space is composed of parameters of the biometric recognition model, selecting a second test data set S2 from the current decision space based on a Non-dominated Ranking Genetic Algorithm NSGA and obtaining a second set O2 of multi-objective values corresponding to the set S2 determined based on a trained agent model, determining a second Pareto solution set of the set S2 based on the set O2, and updating the current decision space based on the set O1, the set O2, the set S1 and the set S2 until a condition is met; and determining a final Pareto solution set based on the first Pareto solution set and the second Pareto solution set in response to the condition being satisfied.

### CROSS-REFERENCE TO RELATED APPLICATION

This application is based on and claims priority under 35 U.S.C. § 119 to Chinese Patent Application No. 202311062137.5, filed on Aug. 22, 2023, in the Chinese Intellectual Property Office, the disclosure of which is incorporated by reference herein in its entirety.

### BACKGROUND

### Field

The inventive concepts relate to a technical field for multi-objective optimization, and more specifically, to a method and device for optimizing parameters of a biometric recognition model.

### Related Art

There are many multi-objective optimization problems in the real world. Multi-objective optimization refers to finding a set of a series of optimal solutions that meet constraints as much as possible in a given decision space. The existing multi-objective optimization methods mainly include a traditional multi-objective optimization method and an intelligent multi-objective optimization method. The traditional multi-objective optimization method optimizes a plurality of objectives by assigning weights to each of objective functions to fuse the objective functions into one objective function. This method is affected by the weights assigned to the objective functions and has a low optimization efficiency. The intelligent multi-objective optimization method takes samples from a decision space by, for example, genetic algorithms, and evaluates the samples by using an agent model to improve the optimization efficiency. However, since the evaluating can only be performed in a partial decision space, respective objectives cannot be effectively optimized in a balanced manner in the partial decision space determined based on the existing intelligent optimization method, which causes that an optimal solution set cannot be found quickly.

### SUMMARY

Some example embodiments of the inventive concepts provide a method and device for optimizing parameters of a biometric recognition model, which are capable of optimizing a plurality of objectives in a balanced manner, thereby enabling rapid acquisition of more Pareto optimal solutions.

According to some example embodiments of the inventive concepts, there is provided a method for optimizing parameters of a biometric recognition model, the method may include: until a condition is met, repeating steps of 1) selecting a first test data set S1 from current decision space based on Latin Hypercube Sampling (LHS), obtaining a first set O1 of multi-objective values corresponding to the set S1 determined based on original evaluation and determining a first Pareto solution set of the set S1 based on the set O1, wherein the decision space is composed of parameters of the biometric recognition model, 2) selecting a second test data set S2 from the current decision space based on a Non-dominated Ranking Genetic Algorithm NSGA and obtaining a second set O2 of multi-objective values corresponding to the set S2 determined based on a trained agent model, and determining a second Pareto solution set of the set S2 based on the set O2, and 3) updating the current decision space based on the set O1, the set O2, the set S1 and the set S2; and determining a final Pareto solution set based on the first Pareto solution set and the second Pareto solution set, in response to the condition being satisfied, wherein each multi-objective value in the set O1 and the set O2 includes a value of each of a plurality of objectives, wherein the plurality of objectives include recognition accuracy and recognition latency of the biometric recognition model.

According to some example embodiments of the inventive concepts, more Pareto solutions may be found quickly during the next iteration of optimization by updating the decision space using test data sets obtained based the LHS and the NSGA and Pareto sets solutions, thereby improving the efficiency of multi-objective optimization to quickly determine better parameters of the biometric recognition model.

Alternatively, the updating the current decision space based on the set O1, the set O2, the set S1 and the set S2 may include: determining a first objective whose optimization is the slowest of the plurality of objectives based on the set O1 and the set O2; selecting N elements from among the set S2 as a subset S2*, wherein a value of the first objective for each of the N elements has a greater difference from a desired value of the first objective; selecting M elements from among the set S1 and the set S2* as a subset Su, wherein an original evaluated value for the first objective of each of the M elements has a greater difference from the desired value of the first objective; determining a correlation coefficient between each decision variable of the current decision space and the first objective based on the set S1, the S2, the set O1 and the set O2; and obtaining an updated current decision space by extending decision space composed of elements of the subset Su based on the correlation coefficient.

According to some example embodiments of the inventive concepts, updating the decision space based on an objective whose optimization is the slowest may speed up the optimization of the objective during the next optimization, thereby allowing a plurality of objectives to be optimized in a balanced manner.

Alternatively, the determining a first objective whose optimization is the slowest of the plurality of objectives based on the set O1 and the set O2 may include: determining an absolute value of difference between a value of each of the plurality of objectives and the desired value of each objective, for each element of the set O1 and the set O2; determining a minimum value of absolute values corresponding to each objective; calculating a ratio of the minimum value corresponding to each objective to the desired value of each objective; and determining an objective corresponding to a maximum value of ratios corresponding to the plurality of objectives as the first objective.

Alternatively, the obtaining the updated current decision space by extending the decision space composed of the elements of the subset Su based on the correlation coefficient may include: updating the current decision space by extending range of value of a decision variable of the decision space composed of the elements of the subset Su in response to an absolute value of the correlation coefficient corresponding to the decision variable being greater than a value.

Alternatively, the updating the current decision space by extending the range of value of the decision variable of the decision space composed of the elements of the subset Su when an absolute value of the correlation coefficient corresponding to the decision variable is greater than a value may include: expanding a lower limit of the range of value of the decision variable in response to the correlation coefficient corresponding to the decision variable being negative; and expanding an upper limit of the range of value of the decision variable in response to the correlation coefficient corresponding to the decision variable being positive.

Alternatively, the condition may be that the number of original evaluations exceeds a value, or the number of repetitions of steps 1)-3) reaches a value.

Alternatively, the correlation coefficient may be a Pearson correlation coefficient.

According to some example embodiments of the inventive concepts, there is provided a device for optimizing parameters of a biometric recognition model, the device may include: processing circuitry configured to, until a condition is met, repeatedly perform operations of 1) selecting a first test data set S1 from current decision space based on Latin Hypercube Sampling (LHS), obtaining a first set O1 of multi-objective values corresponding to the set S1 determined based on original evaluation and determining a first Pareto solution set of the set S1 based on the set O1, wherein the decision space is composed of parameters of the biometric recognition model, 2) selecting a second test data set S2 from the current decision space based on a Non-dominated Ranking Genetic Algorithm (NSGA) and obtaining a second set O2 of multi-objective values corresponding to the set S2 determined based on a trained agent model, and determining a second Pareto solution set of the set S2 based on the set O2, and 3) updating the current decision space based on the set O1, the set O2, the set S1 and the set S2; and a determining unit configured to determine a final Pareto solution set based on the first Pareto solution set and the second Pareto solution set, in response to the conditions being met, wherein each multi-objective value in the set O1 and the set O2 includes a value of each of a plurality of objectives, wherein the plurality of objectives include recognition accuracy and recognition latency of the biometric recognition model.

Alternatively, the processing circuitry may be configured to: determine a first objective whose optimization is the slowest of the plurality of objectives based on the set O1 and the set O2; select N elements from among the set S2 as a subset S2*, wherein a value of the first objective for each of the N elements has a greater difference from a desired value of the first objective; select M elements from among the set S1 and the subset S2* as a subset Su, wherein an original evaluated value for the first objective of each of the M elements has a greater difference from the desired value of the first objective; determine a correlation coefficient between each decision variable of the current decision space and the first objective based on the set S1, the set S2, the set O1 and the set O2; and obtain an updated current decision space by extending decision space composed of elements of the subset Su based on the correlation coefficient.

Alternatively, the processing circuitry may be configured to: determine an absolute value of difference between a value of the each of the plurality of objectives and the desired value of each objective, for each element of the set O1 and the set O2; determine a minimum value of absolute values corresponding to each objective; calculate a ratio of the minimum value corresponding to each objective to the desired value of each objective; and determine an objective corresponding to a maximum value of ratios corresponding to the plurality of objectives as the first objective.

Alternatively, the processing circuitry may be configured to: update the current decision space by extending range of value of a decision variable of the decision space composed of the elements of the subset Su in response to an absolute value of the correlation coefficient corresponding to the decision variable being greater than a value.

Alternatively, the processing circuitry may be configured to: expand the lower limit of the range of value of the decision variable in response to the correlation coefficient corresponding to the decision variable being negative; and expand the upper limit of the range of value of the decision variable in response to the correlation coefficient corresponding to the decision variable being positive.

Alternatively, the condition may be that the number of original evaluations exceeds a value, or the number of repetitions of operations 1)-3) reaches a value.

Alternatively, the correlation coefficient may be a Pearson correlation coefficient.

According to some example embodiments of the inventive concepts, there is provided an electronic device including: a processor; and a memory storing a computer program that when executed by the processor causes the processor to perform the method for optimizing parameters of the biometric recognition model as described herein.

According to some example embodiments of the inventive concepts, there is provided a computer readable storage medium storing a computer program that when executed by a processor causes the processor to implement the method for optimizing parameters of the biometric recognition model as described herein.

### BRIEF DESCRIPTION OF DRAWINGS

The above and other example embodiments and features of the inventive concepts will become more clear through the following descriptions made in conjunction with the figures schematically illustrating some example embodiments, in which:

FIG. 1 illustrates a flowchart of a method for optimizing parameters of a biometric recognition model according to some example embodiments of the inventive concepts; and

FIG. 2 illustrates a distribution of sampling points obtained based on Latin Hypercube Sampling (LHS) in the objective space and a Pareto front corresponding to the sampling points;

FIG. 3 illustrates a distribution of sampling points obtained based on a Non-dominated Ranking Genetic Algorithm (NSGA) in the objective space and a Pareto front corresponding to sampling points;

FIG. 4 illustrates sampling points in the objective space obtained by a multi-objective optimization method according to some example embodiments of the inventive concepts;

FIG. 5 illustrates a block diagram of a structure of a device 500 for optimizing parameters of a biometric recognition model according to some example embodiments of the inventive concepts; and

FIG. 6 is a block diagram illustrating the structure of an electronic device 600 for optimizing parameters of a biometric recognition model according to some example embodiments of the inventive concepts.

### DETAILED DESCRIPTION

Hereinafter, some example embodiments of the inventive concepts are described with reference to the accompanying drawings, in which like reference numerals are used to depict the same or similar elements, features, and structures. However, the inventive concepts are not intended to be limited by the example embodiments described herein and it is intended that the inventive concepts cover all modifications, equivalents, and/or alternatives of the inventive concepts, provided they come within the scope of the appended claims and their equivalents. The terms and words used in the following description and claims are not limited to their dictionary meanings, but, are merely used to enable a clear and consistent understanding of the inventive concepts. Accordingly, it should be apparent to those skilled in the art that the following description of some example embodiments of the inventive concepts is provided for illustration purpose only and not for the purpose of limiting the inventive concepts as defined by the appended claims and their equivalents.

It is to be understood that the singular forms include plural forms, unless the context clearly dictates otherwise. The terms “include,” “include,” and “have”, used herein, indicate disclosed functions, operations, and/or the existence of elements, but does not exclude other functions, operations, and/or elements.

For example, the expressions “A or B,” or “at least one of A and/or B” may indicate A and B, A, or B. For instance, the expression “A or B” or “at least one of A and/or B” may indicate (1) A, (2) B, or (3) both A and B.

In some example embodiments of the inventive concepts, it is intended that when a component (for example, a first component) is referred to as being “coupled” or “connected” with/to another component (for example, a second component), the component may be directly connected to the other component or may be connected through another component (for example, a third component). In contrast, when a component (for example, a first component) is referred to as being “directly coupled” or “directly connected” with/to another component (for example, a second component), another component (for example, a third component) does not exist between the component and the other component.

The expression “configured to”, used in describing some example embodiments of the inventive concepts, may be used interchangeably with expressions such as “suitable for,” “having the capacity to,” “designed to,” “adapted to,” “made to,” and “capable of”, for example, according to the situation. The term “configured to” may not necessarily indicate “specifically designed to” in terms of hardware. Instead, the expression “a device configured to” in some situations may indicate that the device and another device or part are “capable of.” For example, the expression “a processor configured to perform A, B, and C” may indicate a dedicated processor (for example, an embedded processor) for performing a corresponding operation or a general purpose processor (for example, a central processing unit (CPU) or an application processor (AP)) for performing corresponding operations by executing at least one software program stored in a memory device.

The terms used herein are to describe some example embodiments of the inventive concepts, but are not intended to limit the scope of other example embodiments. Unless otherwise indicated herein, all terms used herein, including technical or scientific terms, may have the same meanings that are generally understood by a person skilled in the art. In general, terms defined in a dictionary should be considered to have the same meanings as the contextual meanings in the related art, and, unless clearly defined herein, should not be understood differently or as having an excessively formal meaning. In any case, even terms defined in the present disclosure are not intended to be interpreted as excluding example embodiments of the inventive concepts.

There are many multi-objective optimization problems. For example, when designing a wing structure, decision variables, such as a material and a structural parameter and the like, determine the design specifications of the wing structure. The user expects the design specifications to achieve desired value (for example, the structure is expected to be as light as possible and as stiff as possible), but these specifications often conflict with each other and constrain each other, making it difficult to achieve the desired values at the same time, and therefore, design specifications can only be made as good as possible. For example, when designing a biometric recognition model, parameters of the biometric recognition model may determine characteristics of the biometric model (e.g., recognition accuracy and recognition latency), and the user needs to reasonably determine the parameters of the model so that the designed biometric recognition model has, for example, the highest possible recognition accuracy and/or the lowest possible latency.

However, different ways of determining the parameters may result in different final parameters and different optimization efficiencies. Methods for optimizations for multi-objective engineering or design problems according to some example embodiments of the inventive concepts are applicable to any engineering or design problem related multi-objective optimization to find the set of optimal solutions for the problem.

As an example, methods for optimization of multi-objective engineering or design problems according to some example embodiments of the inventive concepts may be used to optimize parameters of a biometric recognition model.

As an example, the methods for optimization of multi-objective engineering or design problems according to some example embodiments of the inventive concepts may be used to optimize parameters such as materials, structures, etc. that affect performance of a wing structure.

For the convenience of describing the inventive concepts, a multi-objective optimization problem in design of a fingerprint recognition model is described as an example. Specifically, for example, in the design of a fingerprint recognition model for a bank card, it is important to make result of fingerprint recognition as correct as possible and latency of the fingerprint recognition as small as possible. However, a plurality of parameters (e.g., up to 45) in the fingerprint recognition model may affect the correctness and latency of the fingerprint recognition, so it is necessary, or desired, to determine values of the plurality of parameters so that the recognition result of the fingerprint recognition model can be as correct as possible and the latency of the fingerprint recognition model as low as possible. Hereafter, precision (or accuracy) and latency are used as optimization objectives to determine a set of optimal solutions for the plurality of parameters, where the precision (or accuracy) indicates a false acceptance rate (FAR) and/or a false rejection rate (FRR), and thus optimization aims at making the value of the precision as small as possible and value of the latency as small as possible.

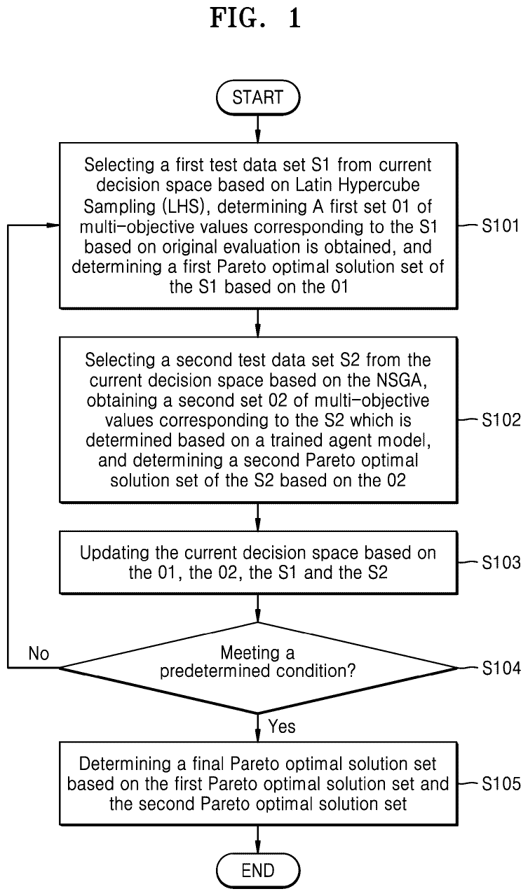

FIG. 1 illustrates a flowchart of a method for optimizing parameters of a biometric recognition model according to some example embodiments of the inventive concepts.

Referring to FIG. 1, at step S101, a first test data set S1 is selected from current decision space based on Latin Hypercube Sampling (LHS), a first set O1 of multi-objective values corresponding to the S1 determined based on original evaluation is obtained, and a first Pareto optimal solution set of the S1 is determined based on the O1, wherein each multi-objective value in the O1 includes a value of each of a plurality of objectives that are optimized, the plurality of objectives include recognition accuracy and recognition latency of the biometric recognition model, and the decision space is composed of parameters to be optimized of the biometric recognition model.

It should be appreciated by those skilled in the art that, taking optimization problem for a plurality of objectives including the accuracy and the latency as an example, the current decision space may indicate a decision space including all available values of the 45 parameters (decision variables). For example, if 100 45-dimensional vectors are selected from the current decision space based on the LHS, each vector of the 100 45-dimensional vectors corresponds to a multi-objective value that includes a value of fingerprint recognition accuracy and a value of fingerprint recognition latency. The 100 vectors correspond to 100 points (i.e., the set O1) in the objective space, and vectors corresponding to the Pareto front of O1 among the 100 vectors constitute the first Pareto optimal solution set.

Since original evaluation needs to be performed on samples selected based the LHS, sampling dimension of LHS is generally small in order to save costs, and therefore, the Pareto optimal solution set that can be found by sampling once is small.

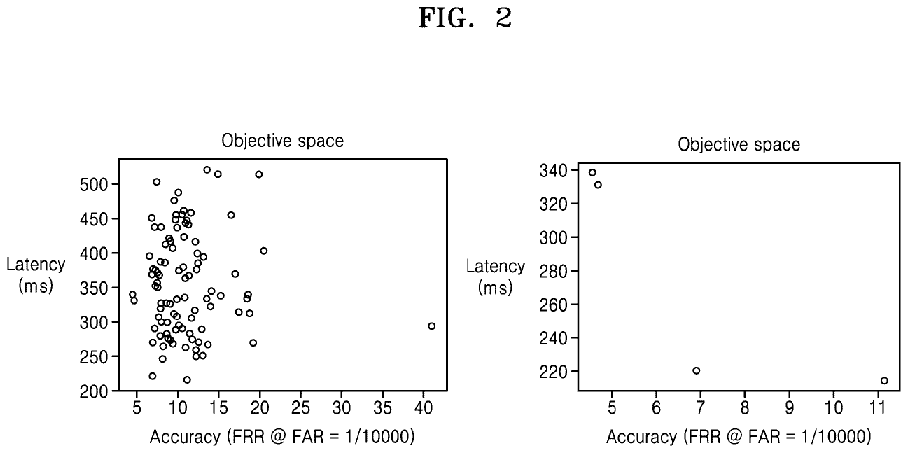

FIG. 2 illustrates a distribution of sampling points obtained based on the LHS in the objective space and Pareto front corresponding to the sampling points.

It should be understood by those skilled in the art that for a 45-dimensional vector, the original evaluation indicates that the 45 parameters are set in the fingerprint recognition model based on this vector and a value of recognition accuracy and a value of recognition latency of the fingerprint recognition model which is based on the vector are determined. Obviously, every single original evaluation needs to take more time and, since the LHS is a uniform sampling, it cannot be guaranteed that respective objectives are optimized in a balanced manner, which leads to low efficiency of the multi-objective optimization.

At step S102, a second test data set S2 is selected from the current decision space based on the NSGA, a second set O2 of multi-objective values corresponding to the S2 which is determined based on a trained agent model is obtained, and a second Pareto optimal solution set of the S2 is determined based on the O2, wherein each multi-objective value in the O2 includes a value of the each of the plurality of objectives.

As an example, the NSGA may be NSGA-I or NSGA-II.

As described above, determining a multi-objective value corresponding to a vector in the decision space based on the original evaluation may take more time. Therefore, using a trained agent model to simulate the original evaluation may reduce computing amount and thus improve the efficiency of multi-objective optimization. For example, according to example embodiments, using a trained agent model to simulate the original evaluation may reduce computing amount and thus improve the efficiency of designing a fingerprint recognition model for a bank card.

Since computing amount of the agent model is small, the decision space may be heavily sampled based on the NSGA (e.g., 1000 vectors may be sampled) and the set O2 of multi-objective values corresponding to the test data set S2 may be obtained by using the agent model to perform approximated evaluation on the samples.

As an example, test data sets and sets of multi-objective values obtained based on the original evaluation corresponding to the test data sets may be used as training samples to train the agent model, and then the trained model is applied to the NSGA algorithm framework to perform the simulation evaluation on the test data set S2 selected based on the NSGA.

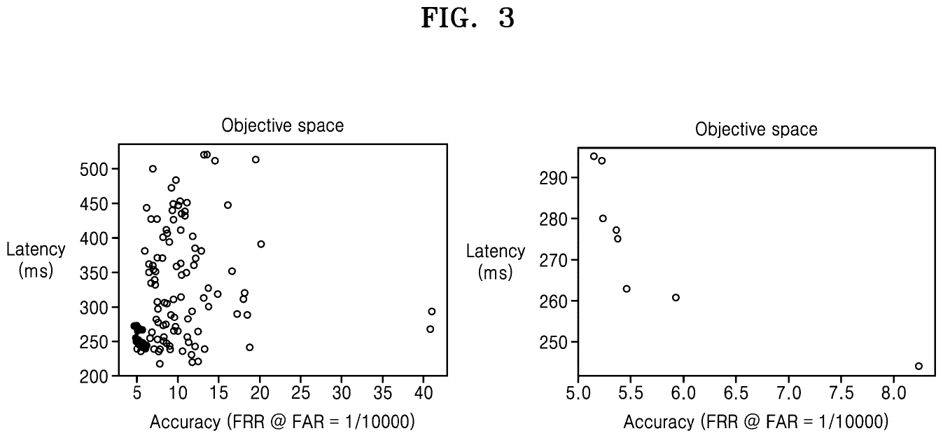

FIG. 3 illustrates a distribution of sampling points obtained based on the NSGA in the objective space and Pareto front corresponding to sampling points. It should be understood by those skilled in the art that each point in the objective space in FIG. 3 is obtained through an agent model, while points in the objective space in FIG. 2 are obtained based on the original evaluation.

A set of points on the left side of FIG. 3 is O2, and vectors corresponding to points forming the Pareto front on the right side in the decision space are the second Pareto optimal solution set.

Comparing FIG. 2 with FIG. 3, it can be seen that a multi-objective optimization method based on the NSGA may find new Pareto optimal solutions. Although the multi-objective optimization method based on the NSGA may find more Pareto optimal solutions, it can be seen from FIG. 3 that sampling points thereof are relatively concentrated, and therefore, all Pareto optimal solutions cannot be found as quickly as possible.

As described above, when there are more decision variables and ranges of values of the decision variables are great, the method based on the LHS or NSGA cannot find all Pareto optimal solutions as quick as possible due to search strategy of the LHS or the NSGA with respect to the decision space.

At step S103, the current decision space may be updated based on the O1, the O2, the S1 and the S2.

At step S104, it is determined whether a predetermined (or alternately given) condition is met, and if the predetermined (or alternately given) condition is met, the method returns to step S101, i.e., steps S101-S103 are repeated until the predetermined (or alternately given) condition is met.

As an example, the agent model may be a model trained and/or updated using the S1 and the O1 in step S101.

For example, the agent model used at step S102 executed the first time may be a first agent model obtained through training by using the S1 and the O1 obtained at step S101 executed for the first time, and the agent model used at step S102 executed the second time may be a second agent model, wherein the second agent model is obtained by updating the first agent model using the S1 and the O1 obtained at step S101 executed for the second time.

As an example, the agent model may be a random forest model or other machine learning model.

As an example, the step S103 may include: determining a first objective whose optimization is the slowest of the plurality of objectives based on the O1 and the O2; selecting N elements from among the S2 as a subset S2*, wherein a value of the first objective for each of the N elements has a greater difference from a desired value of the first objective; selecting M elements from among S1 and S2* as a subset Su, wherein an original evaluated value for the first objective of each of the M elements has a greater difference from the desired value of the first objective; determining a correlation coefficient between each decision variable of the current decision space and the first objective based on the S1, the S2, the O1 and the O2; and obtaining an updated current decision space by extending decision space composed of elements of the Su based on the correlation coefficient, wherein M, N are predetermined (or alternately given) values.

As an example, the determining a first objective whose optimization is the slowest of the plurality of objectives based on the O1 and the O2 may include: determining an absolute value of difference between a value of the each of the plurality of objectives and the desired value of the each objective, for each element of the O1 and the O2; determining a minimum value of absolute values corresponding to the each objective; calculating a ratio of the minimum value corresponding to the each objective to the desired value of the each objective; and determining an objective corresponding to a maximum value of ratios corresponding to the plurality of objectives as the first objective.

As an example, since each of multi-objective values in the O1 and the O2 includes a value of the precision and a value of the latency, the O1 and the O2 may have 1100 values of the precision. An absolute value of difference between each of the 1100 values of the precision and a desired value (which may be a predetermined (or alternately given) value) of the precision may be calculated, and a minimum (or lowest) value Amin of 1100 absolute values corresponding to the precision may be determined. Similarly, the O1 and the O2 may have 1100 values of the latency. An absolute value of difference between each of the 1100 values of the latency and a desired value (which may be a predetermined (or alternately given) value) of the latency may be calculated, and a minimum (or lowest) value Lmin of 1100 absolute values corresponding to the latency may be determined. One of the two objectives that has a greater value is determined as the first objective by comparing size of Amin and size of Lmin. For example, when Amin>Lmin, the precision is determined as the first objective.

As an example, when selecting the N elements or the M elements, if values of the first objective corresponding to two elements are the same, the two elements are selected based on values of a second objective corresponding to the two elements. For example, if the values of the precision corresponding to the two elements are the same, values of the latency corresponding to the two elements are determined, and based on a comparison result for the values of the latency, an element whose value of the latency is greater is preferentially selected.

Those skilled in the art should understand that, for optimization problem of the accuracy and the latency described above, each of the N elements or the M elements may be a 45-dimensional vector.

As an example, according to the value of a ratio of the minimum value corresponding to each objective to a desired value of the each objective, the obtained ratios may be ranked from greatest to smallest. Obviously, optimization of an objective corresponding to the ratio at the top is slower, while optimization of an objective corresponding to a ratio at the bottom is relatively faster.

As an example, since the multi-objective values corresponding to the S2* are obtained by the agent model at step S102, original evaluation values of the plurality of objectives corresponding to the S2* may be determined via original evaluation after the S2* is determined.

Since the S1 corresponds to the O1 and the S2 corresponds to the O2, a correlation coefficient between each decision variable and the first objective may be determined based on the S1, the S2, the O1 and/or the O2. The correlation coefficient reflects influence of change of the decision variable on the first objective.

As an example, the correlation coefficient may be a Pearson correlation coefficient.

As an example, the obtaining the updated current decision space by extending the decision space composed of the elements of the Su based on the correlation coefficient may include: updating the current decision space by extending range of value of a decision variable of the decision space composed of the elements of the Su when an absolute value of the correlation coefficient corresponding to the decision variable is greater than a predetermined (or alternately given) value.

When an absolute value of the correlation coefficient corresponding to a decision variable is great, it means that change of the value of the decision variable may effectively accelerate optimization of the first objective. Therefore, expanding dimension (range of value) of the decision variable in the decision space composed of elements in Su may obtain the updated decision space, which not only reduces scope of the initial decision space, but also speeds up the optimization of an objective whose optimization is slow by searching in the updated decision space more effectively. In this way, during the next round of optimization, it Is high possible that solutions that may accelerate the optimization of the first objective may be found by performing a search from the updated decision space, and thus optimization equilibrium for the plurality of objectives may be improved and the efficiency of solving multi-objective optimization problems may be improved correspondingly.

As an example, the updating the current decision space by extending the range of value of the decision variable of the decision space composed of the elements of the Su when an absolute value of the correlation coefficient corresponding to the decision variable is greater than a predetermined (or alternately given) value may include: expanding a lower limit of the range of value of the decision variable when the correlation coefficient corresponding to the decision variable is negative; and/or expanding an upper limit of the range of value of the decision variable when the correlation coefficient corresponding to the decision variable is positive.

As an example, for example, for Su, a range of value of a first variable among 45 variables is a1-a2, and a range of value of a second variable is b1-b2. When an absolute value of the correlation coefficient between the first variable and the objective whose optimization is the slowest and an absolute value of the correlation coefficient between the second variable and the objective whose optimization is the slowest both exceed a threshold, the correlation coefficient corresponding to the first variable is positive, and the coefficient related to the second variable is negative, the range of value of the first variable is expand to a1-a3, wherein a3>a2, and the range of value of the second variable is expand to b3-b2, where b3<b1. In this way, next time when steps S101 and S102 are executed, sampling range of the first variable is reduced to a1-a3, and sampling range of the second variable is reduced to b3-b2, compared with the initial decision space.

According to some example embodiments of the inventive concepts, the decision space is updated for the next iteration based on decision space updating mechanism, so that optimization resources are allocated to an objective whose optimization is the slowest to eliminate imbalance in optimization speed caused by local data imbalance and enable each objective to achieve balanced optimization in the decision space. Finally, improvement of optimization efficiency of the whole system is achieved.

As an example, the predetermined (or alternately given) condition may be that the number of original evaluations exceeds a predetermined (or alternately given) value, or the number of repetitions of steps 1)-3) reaches a predetermined (or alternately given) value.

It should be understood by those skilled in the art that original evaluations may include original evaluations performed at step S201 and/or original evaluations performed with respect to S2*.

Returning to FIG. 1, at step S105, a final Pareto optimal solution set is determined based on the first Pareto optimal solution set and the second Pareto optimal solution set when the predetermined (or alternately given) condition is satisfied.

It should be understood by those skilled in the art that the final Pareto optimal solution set may be determined based on the first Pareto optimal solution set and the second Pareto obtained each time. For example, if steps S101 and S102 are performed for three times, the final Pareto optimal solution set may be obtained based on three first Pareto optimal solution sets and three second Pareto optimal solution sets.

As an example, when a first Pareto front corresponding to the first Pareto optimal solution set obtained each time and a second Pareto front corresponding to the second Pareto optimal solution set obtained each time are fused together, a part of points corresponding to first Pareto front and the second Pareto front in the objective space will no longer belong to a Pareto front, and at least one 45-dimensional vector in the decision space corresponding to the Pareto front obtained after fusion is the final Pareto optimal solution set. After obtaining the final Pareto optimal solution set, the user may select a solution in the final Pareto optimal solution set according to preference or need.

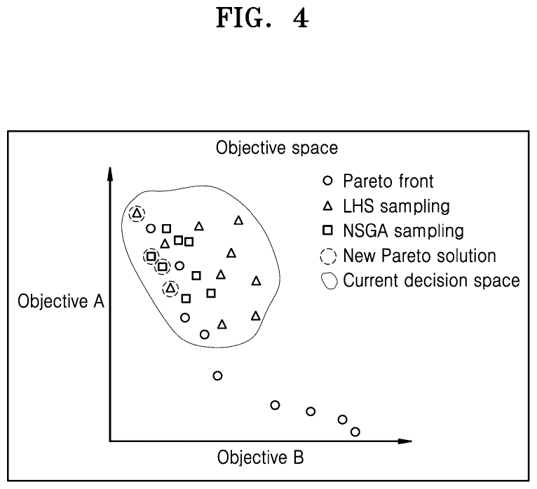

FIG. 4 illustrates sampling points in the objective space obtained by a multi-objective optimization method according to some example embodiments of the inventive concepts.

Referring to FIG. 4, it can be seen that, a new Pareto optimal solution set is quickly found based on the LHS and NSGA by narrowing the current decision space.

According to some example embodiments of the inventive concepts, searching optimal solutions in the current decision space based on the LHS and the NSGA, the LHS and the NSGA complementing each other may provide effective reference information for updating the decision space, and the decision space is updated based on the obtained reference information to make it possible to quickly find more Pareto optimal solutions in the updated decision space.

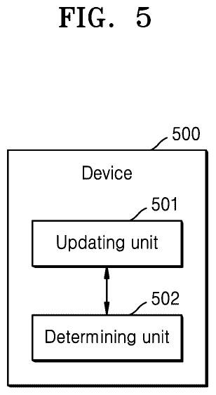

The method for optimizing parameters of the biometric recognition model according to some example embodiments of the inventive concepts has been described above with reference to FIGS. 1 to 4, and a device for optimizing parameters of the biometric recognition model according to some example embodiments of the inventive concepts is described below with reference to FIG. 5.

FIG. 5 illustrates a block diagram of a structure of a device 500 for optimizing parameters of a biometric recognition model according to some example embodiments of the inventive concepts.

Referring to FIG. 5, the device 500 may include an updating unit 501 and/or a determining unit 502.

It should be understood by those skilled in the art that the device 500 may additionally include other components and that any of the components included in device 500 may be combined or divided.

For example, the updating unit 501 and/or the determining unit 502 may be implemented by processing circuitry.

As an example, the updating unit 501 may be configured to: until a predetermined (or alternately given) condition is met, repeatedly perform operations of 1) selecting a first test data set S1 from current decision space based on Latin Hypercube Sampling (LHS), obtaining a first set O1 of multi-objective values corresponding to the S1 determined based on original evaluation and determining a first Pareto optimal solution set of the S1 based on the O1, wherein the decision space is composed of parameters to be optimized of the biometric recognition model; 2) selecting a second test data set S2 from the current decision space based on a Non-dominated Ranking Genetic Algorithm NSGA and obtaining a second set O2 of multi-objective values corresponding to the S2 determined based on a trained agent model, and determining a second Pareto optimal solution set of the S2 based on the O2; and 3) updating the current decision space based on the O1, the O2, the S1 and/or the S2, wherein each multi-objective value in the O1 and the O2 includes a value of each of a plurality of objectives that are optimized, and the plurality of objectives include recognition accuracy and/or recognition latency of the biometric recognition model.

As an example, the predetermined (or alternately given) condition may be that the number of original evaluations exceeds a predetermined (or alternately given) value, or the number of repetitions of operations 1)-3) reaches a predetermined (or alternately given) value.

As an example, the updating unit 501 may be configured to determine a first objective whose optimization is the slowest of the plurality of objectives based on the O1 and the O2; select N elements from among the S2 as a subset S2*, wherein a value of the first objective for each of the N elements has a greater difference from a desired value of the first objective; select M elements from among S1 and S2* as a subset Su, wherein an original evaluated value for the first objective of each of the M elements has a greater difference from the desired value of the first objective; determine a correlation coefficient between each decision variable of the current decision space and the first objective based on the S1, the S2, the O1 and/or the O2; and obtain an updated current decision space by extending decision space composed of elements of the Su based on the correlation coefficient, wherein M, N are predetermined (or alternately given) values.

As an example, the updating unit 501 may be configured to determine an absolute value of difference between a value of the each of the plurality of objectives and the desired value of the each objective, for each element of the O1 and the O2, determine a minimum value of absolute values corresponding to the each objective, calculate a ratio of the minimum value corresponding to the each objective to the desired value of the each objective, and determine an objective corresponding to a maximum value of ratios corresponding to the plurality of objectives as the first objective.

As an example, the updating unit 501 may be configured to update the current decision space by extending range of value of a decision variable of the decision space composed of the elements of the Su when an absolute value of the correlation coefficient corresponding to the decision variable is greater than a predetermined (or alternately given) value.

As an example, the updating unit 501 may be configured to expand the lower limit of the range of value of the decision variable when the correlation coefficient corresponding to the decision variable is negative, and expand the upper limit of the range of value of the decision variable when the correlation coefficient corresponding to the decision variable is positive.

As an example, the correlation coefficient is a Pearson correlation coefficient.

As an example, the determining unit 502 may be configured to determine a final Pareto optimal solution set based on the first Pareto optimal solution set and the second Pareto optimal solution set, when the predetermined (or alternately given) conditions are met.

According to some example embodiments of the inventive concepts, there is provided an electronic device including a processor; and a memory storing a computer program that when executed by the processor causes the processor to perform the method for optimizing parameters of the biometric recognition model as described herein.

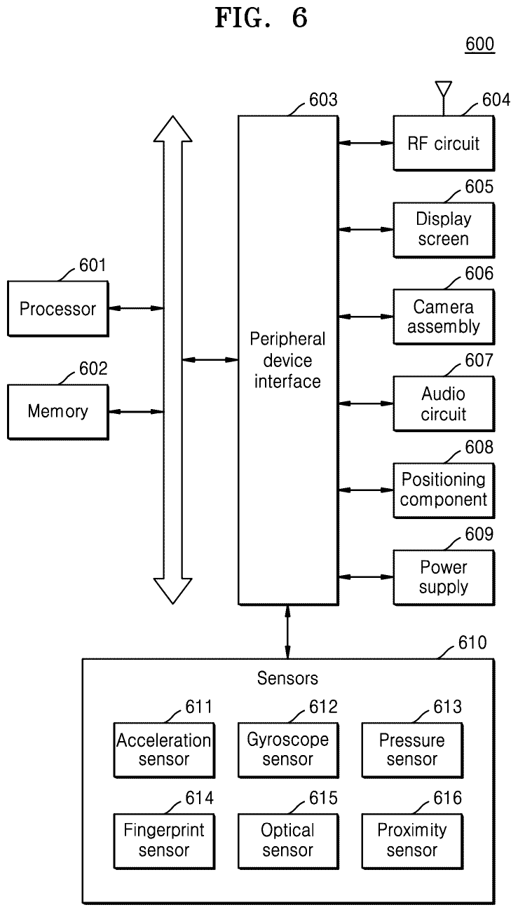

FIG. 6 is a block diagram illustrating a structure of an electronic device 600 for optimizing parameters of a biometric recognition model according to some example embodiments of the inventive concepts.

The electronic device 600 may be, for example, a smart phone, a tablet computer, an MP3 (Moving Picture Experts Group Audio Layer III) player, MP4 (Moving Picture Experts Group Audio Layer IV) Player, laptop and/or desktop computer. The electronic device 600 may also be called user equipment, portable terminal, laptop terminal, desktop terminal and other names.

Generally, the electronic device 600 includes a processor 601 and/or a memory 602.

The processor 601 may include one or more processing cores, such as a 4-cores processor, an 8-cores processor, and so on. The processor 1001 may be implemented in at least one hardware form of DSP (Digital Signal Processing), FPGA (Field Programmable Gate Array), PLA (Programmable Logic Array). The processor 601 may also include a main processor and/or a slave processor. The main processor is a processor used to process data in a awake state, also called a CPU (Central Processing Unit); the slave processor is a low-power processor used to process data in a standby state. In some example embodiments, the processor 601 may be integrated with a GPU (Graphics Processing Unit) used to render and draw content to be displayed on the display screen. In some example embodiments, the processor 601 may further include an AI (Artificial Intelligence) processor used to process calculation operations related to machine learning.

The memory 602 may include one or more computer-readable storage media, which may be non-transitory. The memory 602 may also include a high-speed random access memory and/or a non-volatile memory, such as one or more magnetic disk storage devices and/or flash memory storage devices. In some example embodiments, the non-transitory computer-readable storage medium in the memory 602 is used to store at least one instruction used to be executed by the processor 601 to implement the method for optimizing parameters of the biometric recognition model in the example embodiments.

In some example embodiments, the electronic device 600 may optionally further include: a peripheral device interface 603 and/or at least one peripheral device. The processor 601, the memory 602, and/or the peripheral device interface 603 may be connected by a bus and/or a signal line. Each, or one or more, peripheral device may be connected to the peripheral device interface 603 through a bus, a signal line, and/or a circuit board. Specifically, the peripheral devices includes: a radio frequency circuit 604, a touch screen 605, a camera 606, an audio circuit 607, a positioning component 608, and/or a power supply 609.

The peripheral device interface 603 may be used to connect at least one peripheral device related to I/O (Input/Output) to the processor 601 and/or the memory 602. In some example embodiments, the processor 601, the memory 602, and/or the peripheral device interface 603 are integrated on the same chip or circuit board; in some example embodiments, any one or two of the processor 601, the memory 602, and/or the peripheral device interface 603 may be implemented on a separate chip or circuit board, which is not limited in example embodiments.

The radio frequency circuit 604 is used for receiving and transmitting RF (Radio Frequency) signals, also called electromagnetic signals. The radio frequency circuit 604 communicates with a communication network and other communication devices through electromagnetic signals. The radio frequency circuit 604 converts electrical signals into electromagnetic signals for transmission, and/or converts received electromagnetic signals into electrical signals. Alternatively, the radio frequency circuit 604 includes: an antenna system, an RF transceiver, one or more amplifiers, a tuner, an oscillator, a digital signal processor, a codec chipset, a user identity module card, and so on. The radio frequency circuit 604 can communicate with other terminals through at least one wireless communication protocol. The wireless communication protocol includes, but is not limited to: metropolitan area networks, various generations of mobile communication networks (2G, 3G, 4G, and/or 5G), wireless local area networks and/or Wi-Fi (Wireless Fidelity) networks. In some example embodiments, the radio frequency circuit 604 may also include a circuit related to NFC (Near Field Communication), which is not limited in the example embodiments.

The display screen 605 is used to display a UI (User Interface). The UI may include graphics, text, icons, videos, and any combination thereof. When the display screen 605 is a touch display screen, the display screen 605 also has an ability to collect touch signals on or above the surface of the display screen 605. The touch signal may be input to the processor 601 as a control signal for processing. At this time, the display screen 605 may also be used to provide virtual buttons and/or virtual keyboards, also called soft buttons and/or soft keyboards. In some example embodiments, the display screen 605 may be one display screen, which is arranged on the front panel of the electronic device 600; in some example embodiments, the display screen 605 may be at least two display screens 605, which are respectively arranged on different surfaces of a terminal or in a folded design. In still some other example embodiments, the display screen 605 may be a flexible display screen, which is arranged on the curved surface or the folding surface of the electronic device 600. Furthermore, the display screen 605 may also be set as a non-rectangular irregular shape, that is, a special-shaped screen. The display screen 605 may be made of materials such as LCD (Liquid Crystal Display), OLED (Organic Light-Emitting Diode).

The camera assembly 606 is used to capture images or videos. Alternatively, the camera assembly 606 includes a front camera and/or a rear camera. Generally, the front camera is set on the front panel of the terminal, and the rear camera is set on the back of the terminal. In some example embodiments, the rear camera is at least two cameras, each of which is a main camera, a depth-of-field camera, a wide-angle camera, and/or a telephoto camera, so as to realize a fusion of the main camera and the depth-of-field camera to realize the background blur function, a fusion of the main camera and the wide-angle camera to realize panoramic shooting and VR (Virtual Reality) shooting function or other fusion shooting functions. In some example embodiments, the camera assembly 606 may also include a flash. The flash may be a single-color temperature flash or a dual-color temperature flash. Dual color temperature flash refers to a combination of warm light flash and cold light flash, which may be used for light compensation under different color temperatures.

The audio circuit 607 may include a microphone and a speaker. The microphone is used to collect sound waves of the user and the environment, and convert the sound waves into electrical signals and input them to the processor 601 for processing, or input to the radio frequency circuit 604 to implement voice communication. For the purpose of stereo collection or noise reduction, there may be multiple microphones, which are respectively set in different parts of the electronic device 600. The microphone may also be an array microphone or an omnidirectional collection microphone. The speaker is used to convert the electrical signal from the processor 601 or the radio frequency circuit 604 into sound waves. The speaker may be a traditional thin-film speaker and/or a piezoelectric ceramic speaker. When the speaker is a piezoelectric ceramic speaker, it may not only convert electrical signals into sound waves that are audible to humans, but also convert electrical signals into sound waves that are inaudible to humans for distance measurement and other purposes. In some example embodiments, the audio circuit 607 may also include a headphone jack.

The positioning component 608 is used to locate a current geographic location of the electronic device 600 to implement navigation and/or LBS (Location Based Service). The positioning component 608 may be a positioning component based on the GPS (Global Positioning System) of the United States, the Beidou system of China, the GLONASS system of Russia, and/or the Galileo system of the European Union.

The power supply 609 is used to supply power to various components in the electronic device 600. The power supply 609 may be alternating current, direct current, disposable batteries, and/or rechargeable batteries. When the power supply 609 includes a rechargeable battery, the rechargeable battery may support wired charging and/or wireless charging. The rechargeable battery may also be used to support fast charging technology.

In some example embodiments, the electronic device 600 further includes one or more sensors 610. The one or more sensors 610 include, but are not limited to: an acceleration sensor 611, a gyroscope sensor 612, a pressure sensor 613, a fingerprint sensor 614, an optical sensor 615, and/or a proximity sensor 616.

The acceleration sensor 611 may detect the magnitude of acceleration on the three coordinate axes of the coordinate system established by the terminal 600. For example, the acceleration sensor 611 may be used to detect the components of gravitational acceleration on three coordinate axes. The processor 601 may control the touch screen 605 to display the user interface in a horizontal view or a vertical view according to the gravity acceleration signal collected by the acceleration sensor 611. The acceleration sensor 611 may also be used for the collection of game and/or user motion data.

The gyroscope sensor 612 may detect the body direction and rotation angle of the electronic device 600, and the gyroscope sensor 612 may cooperate with the acceleration sensor 611 to collect the user's 3D actions on the electronic device 600. The processor 601 may implement the following functions according to the data collected by the gyroscope sensor 612: motion sensing (for example, changing the UI according to the user's tilt operation), image stabilization during shooting, game control, and/or inertial navigation.

The pressure sensor 613 may be disposed on a side frame of the electronic device 600 and/or the lower layer of the touch screen 605. When the pressure sensor 613 is arranged on the side frame of the electronic device 600, the user's holding signal for the terminal 600 may be detected, and the processor 601 performs left and right hand recognition or quick operation according to the holding signal collected by the pressure sensor 613. When the pressure sensor 613 is arranged on the lower layer of the touch display screen 605, the processor 601 controls an operability control element on the UI according to the user's pressure operation on the touch display screen 605. The operability control element includes at least one of a button control element, a scroll bar control element, an icon control element, and/or a menu control element.

The fingerprint sensor 614 is used to collect a user's fingerprint, and the processor 601 identifies the user's identity according to the fingerprint collected by the fingerprint sensor 614, or the fingerprint sensor 614 identifies the user's identity according to the collected fingerprint. When it is recognized that the user's identity is a trusted identity, the processor 601 authorizes the user to perform related sensitive operations, including unlocking a screen, viewing encrypted information, downloading software, paying, and/or changing settings. The fingerprint sensor 614 may be provided on the front, back and/or side of the electronic device 600. When the electronic device 600 is provided with a physical button or a manufacturer logo, the fingerprint sensor 614 may be integrated with the physical button or the manufacturer logo.

The optical sensor 615 is used to collect the ambient light intensity. In some example embodiments, the processor 601 may control the display brightness of the touch screen 605 according to the intensity of the ambient light collected by the optical sensor 615. Specifically, when the ambient light intensity is high, the display brightness of the touch display screen 605 is increased; when the ambient light intensity is low, the display brightness of the touch display screen 605 is decreased. In some example embodiments, the processor 601 may also dynamically adjust the shooting parameters of the camera assembly 606 according to the ambient light intensity collected by the optical sensor 615.

The proximity sensor 616, also called a distance sensor, is usually arranged on a front panel of the electronic device 600. The proximity sensor 616 is used to collect a distance between the user and the front of the electronic device 600. In some example embodiments, when the proximity sensor 616 detects that the distance between the user and the front of the electronic device 600 gradually decreases, the processor 601 controls the touch screen 605 to switch from on-screen state to off-screen state; when the proximity sensor 616 detects that the distance between the user and the front of the electronic device 600 gradually increases, the processor 601 controls the touch display screen 605 to switch from the off-screen state to the on-screen state.

Those skilled in the art may understand that the structure shown in FIG. 6 does not constitute a limitation on the electronic device 600, and may include more or fewer components than shown, or combine certain components, or adopt different component arrangements.

According to some example embodiments of the inventive concepts, there may be provided a computer-readable storage medium storing instructions, when executed by at least one processor, causing the at least one processor to perform the method for optimizing parameters of the biometric recognition model according to the example embodiments. Examples of computer-readable storage media here include: read only memory (ROM), random access programmable read only memory (PROM), electrically erasable programmable read only memory (EEPROM), random access memory (RAM), dynamic random access memory (DRAM), static random access memory (SRAM), flash memory, non-volatile memory, CD-ROM, CD-R, CD+R, CD-RW, CD+RW, DVD-ROM, DVD-R, DVD+R, DVD-RW, DVD+RW, DVD-RAM, BD-ROM, BD-R, BD-R LTH, BD-RE, Blu-ray or optical disc storage, hard disk drive (HDD), solid state Hard disk (SSD), card storage (such as multimedia card, secure digital (SD) card or extreme digital (XD) card), magnetic tape, floppy disk, magneto-optical data storage device, optical data storage device, hard disk, solid state disk and any other devices configured to store computer programs and any associated data, data files, and data structures in a non-transitory manner, and provide the computer programs and any associated data, data files, and data structures to the processor or the computer, so that the processor or the computer can execute the computer program. The computer program in the above-mentioned computer-readable storage medium may run in an environment deployed in computing equipment such as a client, a host, an agent device, a server, etc. In addition, in one example, the computer program and any associated data, data files and data structures are distributed on networked computer systems, so that computer programs and any associated data, data files, and data structures are stored, accessed, and executed in a distributed manner through one or more processors or computers.

According to some example embodiments of the inventive concepts, there may be provided a computer program product, wherein instructions in the computer program product may be executed by a processor of a computer device to implement the method for optimizing parameters of the biometric recognition model described herein.

The terms “optimize,” “optimized,” “optimizing,” “optimal,” “optimization,” etc., as used herein are understood as meaning improve, improved, improving, improvement, etc.

One or more of the elements disclosed above may include or be implemented in one or more processing circuitries such as hardware including logic circuits; a hardware/software combination such as a processor executing software; or a combination thereof. For example, the processing circuitries more specifically may include, but is not limited to, a central processing unit (CPU), an arithmetic logic unit (ALU), a digital signal processor, a microcomputer, a field programmable gate array (FPGA), a System-on-Chip (SoC), a programmable logic unit, a microprocessor, application-specific integrated circuit (ASIC), etc.

Those skilled in the art will easily think of other example embodiments of the inventive concepts after considering the specification and practicing the disclosure disclosed herein. The present disclosure is intended to cover any variations, uses, or adaptive changes of the inventive concepts. These variations, uses, or adaptive changes follow the general principles of the inventive concepts and include common knowledge or conventional technical means in the technical field that are not disclosed in the example embodiments. The specification and the example embodiments are to be regarded as examples only, and the actual scope and spirit of the inventive concepts are pointed out by the following claims.

What is claimed is:

1. A method for optimizing parameters of a biometric recognition model, comprising:
until a condition is met, repeating steps of 1) selecting a first test data set S1 from current decision space based on Latin Hypercube Sampling (LHS), obtaining a first set O1 of multi-objective values corresponding to the set S1 determined based on original evaluation, and determining a first Pareto solution set of the set S1 based on the set O1, wherein the decision space is composed of parameters of the biometric recognition model, 2) selecting a second test data set S2 from the current decision space based on a Non-dominated Ranking Genetic Algorithm NSGA, and obtaining a second set O2 of multi-objective values corresponding to the set S2 determined based on a trained agent model, and determining a second Pareto solution set of the set S2 based on the set O2, and 3) updating the current decision space based on the set O1, the set O2, the set S1 and the set S2; and
determining a final Pareto solution set based on the first Pareto solution set and the second Pareto solution set, in response to the condition being satisfied,
wherein each multi-objective value in the set O1 and the set O2 comprises a value of each of a plurality of objectives, wherein the plurality of objectives comprise recognition accuracy and recognition latency of the biometric recognition model.

2. The method of claim 1, wherein the updating the current decision space based on the set O1, the set O2, the set S1 and the set S2 comprises:
determining a first objective whose optimization is the slowest of the plurality of objectives based on the set O1 and the set O2;
selecting N elements from among the set S2 as a subset S2*, wherein a value of the first objective for each of the N elements has a greater difference from a desired value of the first objective;
selecting M elements from among the set S1 and the subset S2* as a subset Su, wherein an original evaluated value for the first objective of each of the M elements has a greater difference from the desired value of the first objective;
determining a correlation coefficient between each decision variable of the current decision space and the first objective based on the set S1, the set S2, the set O1 and the set O2; and
obtaining an updated current decision space by extending decision space composed of elements of the subset Su based on the correlation coefficient.

3. The method of claim 2, wherein the determining the first objective whose optimization is the slowest of the plurality of objectives based on the set O1 and the set O2 comprises:
determining an absolute value of difference between a value of each of the plurality of objectives and the desired value of each objective, for each element of the set O1 and the set O2;
determining a minimum value of absolute values corresponding to each objective;
calculating a ratio of the minimum value corresponding to each objective to the desired value of each objective; and
determining an objective corresponding to a maximum value of ratios corresponding to the plurality of objectives as the first objective.

4. The method of claim 3, wherein the obtaining the updated current decision space by extending the decision space composed of the elements of the Su based on the correlation coefficient comprises:
updating the current decision space by extending range of value of a decision variable of the decision space composed of the elements of the subset Su in response to an absolute value of the correlation coefficient corresponding to the decision variable being greater than a value.

5. The method of claim 4, wherein the updating the current decision space by extending the range of value of the decision variable of the decision space composed of the elements of the subset Su in response to an absolute value of the correlation coefficient corresponding to the decision variable being greater than the value comprises:
expanding a lower limit of the range of value of the decision variable in response to the correlation coefficient corresponding to the decision variable being negative; and
expanding an upper limit of the range of value of the decision variable in response to the correlation coefficient corresponding to the decision variable being positive.

6. The method of claim 1, wherein the condition is that a number of original evaluations exceeds a value, or the number of repetitions of steps 1)-3) reaches a value.

7. The method of claim 2, wherein the correlation coefficient is a Pearson correlation coefficient.

8. A device for optimizing parameters of a biometric recognition model, comprising:
processing circuitry configured to:
until a condition is met, repeatedly perform operations of 1) selecting a first test data set S1 from current decision space based on Latin Hypercube Sampling (LHS), obtaining a first set O1 of multi-objective values corresponding to the set S1 determined based on original evaluation and determining a first Pareto solution set of the set S1 based on the set O1, wherein the decision space is composed of parameters of the biometric recognition model, 2) selecting a second test data set S2 from the current decision space based on a Non-dominated Ranking Genetic Algorithm (NSGA) and obtaining a second set O2 of multi-objective values corresponding to the set S2 determined based on a trained agent model, and determining a second Pareto solution set of the set S2 based on the set O2, and 3) updating the current decision space based on the set O1, the set O2, the set S1 and the set S2; and
determine a final Pareto solution set based on the first Pareto solution set and the second Pareto solution set, in response to the conditions being met,
wherein each multi-objective value in the set O1 and the set O2 comprises a value of each of a plurality of objectives, wherein the plurality of objectives comprise recognition accuracy and recognition latency of the biometric recognition model.

9. The device of claim 8, wherein the processing circuitry is configured to:
determine a first objective whose optimization is the slowest of the plurality of objectives based on the set O1 and the set O2;
select N elements from among the set S2 as a subset S2*, wherein a value of the first objective for each of the N elements has a greater difference from a desired value of the first objective;
select M elements from among the set S1 and the subset S2* as a subset Su, wherein an original evaluated value for the first objective of each of the M elements has a greater difference from the desired value of the first objective;
determine a correlation coefficient between each decision variable of the current decision space and the first objective based on the set S1, the set S2, the set O1 and the set O2; and
obtain an updated current decision space by extending decision space composed of elements of the subset Su based on the correlation coefficient.

10. The device of claim 9, wherein the processing circuitry is configured to:
determine an absolute value of difference between a value of each of the plurality of objectives and the desired value of each objective, for each element of the set O1 and the set O2;
determine a minimum value of absolute values corresponding to each objective;
calculate a ratio of the minimum value corresponding to each objective to the desired value of each objective; and
determine an objective corresponding to a maximum value of ratios corresponding to the plurality of objectives as the first objective.

11. The device of claim 10, wherein the processing circuitry is configured to:
update the current decision space by extending range of value of a decision variable of the decision space composed of the elements of the subset Su in response to an absolute value of the correlation coefficient corresponding to the decision variable being greater than a value.

12. The device of claim 11, wherein the processing circuitry is configured to:
expand the lower limit of the range of value of the decision variable in response to the correlation coefficient corresponding to the decision variable being negative; and
expand the upper limit of the range of value of the decision variable in response to the correlation coefficient corresponding to the decision variable being positive.

13. The device of claim 8, wherein the condition is that a number of original evaluations exceeds a value, or a number of repetitions of operations 1)-3) reaches a value.

14. The device of claim 9, wherein the correlation coefficient is a Pearson correlation coefficient.

15. A method for optimizing parameters of a biometric recognition model, comprising:
determining a first Pareto solution set and a second Pareto solution set by
selecting a first test data set from a decision space based on Latin Hypercube Sampling (LHS), the decision space including parameters of the biometric recognition model,
determining a first set of multi-objective values corresponding to the first test data set based on original evaluation,
determining the first Pareto solution set of the first data set based on the first set of multi-objective values,
selecting a second test data set from the decision space based on a Non-dominated Ranking Genetic Algorithm (NSGA),
determining a second set of multi-objective values corresponding to the second test data set based on a trained agent model,
determining the second Pareto solution set of the second test data set based on the second set of multi-objective values, and
updating the decision space based on the first test data set, the second test data set, the first set of multi-objective values, and the second set of multi-objective values;
repeating the determining the first Pareto solution set and the second Pareto solution set in response to a condition not being satisfied; and
determining a final Pareto solution set based on the first Pareto solution set and the second Pareto solution set in response to the condition being satisfied,
wherein each multi-objective value in first set of multi-objective values and the second set of multi-objective values includes a value of each of a plurality of objectives, and
wherein the plurality of objectives include recognition accuracy and recognition latency of the biometric recognition model.

16. The method of claim 15, wherein the updating the decision space based on the first test data set, the second test data set, the first set of multi-objective values, and the second set of multi-objective values comprises:
determining a first objective whose optimization is the slowest of the plurality of objectives based on the first test data set and the second test data set;
selecting N elements from among the second set of multi-objective values as a first subset, wherein a value of the first objective for each of the N elements has a greater difference from a desired value of the first objective;
selecting M elements from among the first set of multi-objective values and the first subset as a second subset, wherein an original evaluated value for the first objective of each of the M elements has a greater difference from the desired value of the first objective;
determining a correlation coefficient between each decision variable of the decision space and the first objective based on the first test data set, the second test data set, the first set of multi-objective values, and the second set of multi-objective values; and
obtaining an updated decision space by extending a decision space composed of elements of the second subset based on the correlation coefficient.

17. The method of claim 16, wherein the determining the first objective whose optimization is the slowest of the plurality of objectives based on the first test data set and the second test data set comprises:
determining an absolute value of difference between a value of each of the plurality of objectives and the desired value of each objective, for each element of the first test data set and the second test data set;
determining a minimum value of absolute values corresponding to each objective;
calculating a ratio of the minimum value corresponding to each objective to the desired value of each objective; and
determining an objective corresponding to a maximum value of ratios corresponding to the plurality of objectives as the first objective.

18. The method of claim 17, wherein the obtaining the updated decision space by extending the decision space composed of the elements of the second subset based on the correlation coefficient comprises:
updating the decision space by extending range of value of a decision variable of the decision space composed of the elements of the second subset in response to an absolute value of the correlation coefficient corresponding to the decision variable being greater than a value.

19. The method of claim 18, wherein the updating the decision space by extending the range of value of the decision variable of the decision space composed of the elements of the second subset in response to an absolute value of the correlation coefficient corresponding to the decision variable being greater than the value comprises:
expanding a lower limit of the range of value of the decision variable in response to the correlation coefficient corresponding to the decision variable being negative; and
expanding an upper limit of the range of value of the decision variable in response to the correlation coefficient corresponding to the decision variable being positive.

20. A computer readable storage medium storing a computer program that when executed by a processor causes the processor to implement the method for optimizing parameters of the biometric recognition model of any one claim 1.
